(19) United States
(12) Patent Application Publication
(10) Pub. No.: US 2021/0055843 A1
(43) Pub. Date: Feb. 25, 2021

(54) INFORMATION PROCESSING APPARATUS SEARCHING FOR SPECIFIC CHARACTER STRING FROM TEXT DISPLAYED ON SCREEN OF DISPLAY DEVICE

(71) Applicant: KYOCERA Document Solutions Inc., Osaka (JP)

(72) Inventor: Takushi DANDOKO, Osaka (JP)

(73) Assignee: KYOCERA Document Solutions Inc., Osaka (JP)

(21) Appl. No.: 16/984,738

(22) Filed: Aug. 4, 2020

(30) Foreign Application Priority Data
Aug. 21, 2019 (JP) 2019-151523

(51) Int. Cl. G06F 3/0486; G06F 3/0484

(52) U.S. Cl. CPC G06F 3/0486; G06F 3/04847; G06F 3/04842

(57) ABSTRACT

An information processing apparatus includes a display device, a touch panel, and a control device. The touch panel is provided on a screen of the display device. The control device includes a processor and, as a result of executing a control program by the processor, functions as a controller. The controller causes the display device to display a text on the screen thereof, determines, through the touch panel, drag operation performed on a desired character string of the text displayed on the screen of the display device, and upon determination of flick operation performed on the desired character string following the drag operation, searches for a character string in agreement with the desired character string in the text, and changes a display mode of the character string searched for.

### INCORPORATION BY REFERENCE

This application claims priority to Japanese Patent Application No. 2019-151523 filed on Aug. 21, 2019, the entire contents of which are incorporated by reference herein.

### BACKGROUND

This disclosure relates to an information processing apparatus including a display device and more specifically to a technology of searching for a specific character string from a text displayed on a screen of the display device.

A conventional information processing apparatus includes: a display device; and a touch panel which is provided on a screen of the display device. In such the information processing apparatus, while a text is displayed on the screen of the display device, when a desired character string is inputted through, for example, keyboard operation, and searching for the character string is instructed, the inputted character string included in the text is searched for and the searched character string is highlighted.

In a conventional electronic device, while an English sentence is displayed at a display device, when a word is specified through keyboard or touch panel operation and execution of a search for the word is instructed, the word is searched for from dictionary data and the word in the English sentence is highlighted.

### SUMMARY

As one aspect of this disclosure, technology obtained by further improving the technology described above is suggested.

An information processing apparatus according to one aspect of this disclosure includes a display device, a touch panel, and a control device. The touch panel is provided on a screen of the display device. The control device includes a processor and, as a result of executing a control program by the processor, functions as a controller. The controller causes the display device to display a text on the screen thereof, determines, through the touch panel, drag operation performed on a desired character string of the text displayed on the screen of the display device, and upon determination of flick operation performed on the desired character string following the drag operation, searches for a character string in agreement with the desired character string in the text subjected to the drag operation, and causes the display device to display the character string searched for, by changing a display mode thereof.

### BRIEF DESCRIPTION OF THE DRAWINGS

FIG. 1 is a plan view illustrating outer appearance of an information processing apparatus according to one embodiment of this disclosure.

FIG. 2 is a block diagram illustrating inner configuration of the information processing apparatus according to this embodiment.

FIG. 3A is a diagram illustrating a horizontally written text.

FIG. 3B is a diagram illustrating a vertically written text.

FIG. 4 is a flowchart illustrating procedures of control performed for searching for and highlighting a desired character string in accordance with, for example, drag operation or flick operation.

FIGS. 5A to 5D are diagrams each illustrating a state of a text displayed on a screen of a display device in accordance with the procedures of the control illustrated in FIG. 4.

### DETAILED DESCRIPTION

Hereinafter, one embodiment of this disclosure will be described with reference to the drawings.

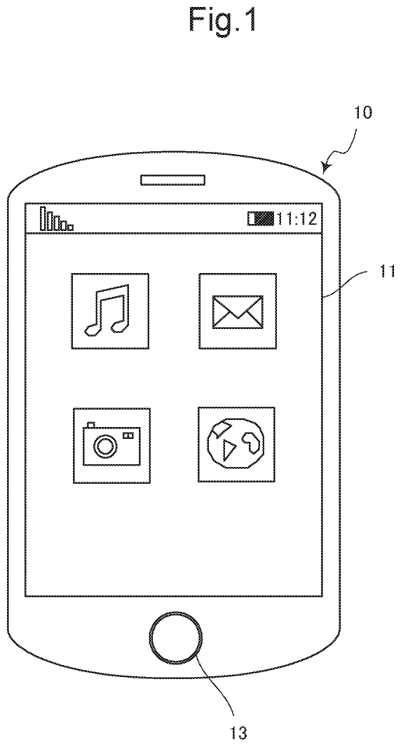

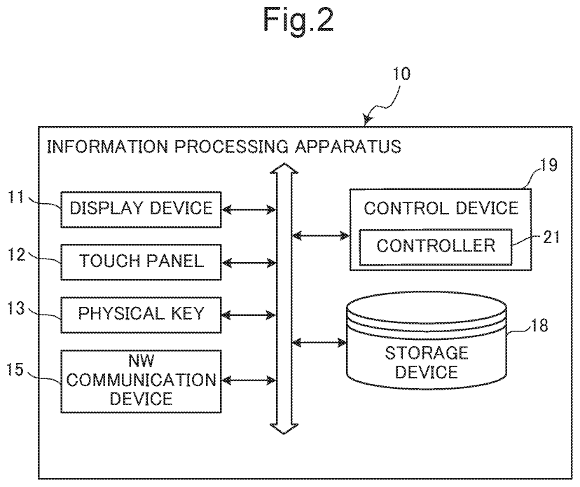

FIG. 1 is a plan view illustrating outer appearance of an information processing apparatus according to one embodiment of this disclosure. FIG. 2 is a block diagram illustrating inner configuration of the information processing apparatus according to this embodiment.

An information processing apparatus 10 of this embodiment is, for example, a smartphone or a mobile device, and includes a display device 11, a touch panel 12, a physical key 13, a network communication device (NW communication device) 15, a storage device 18, and a control device 19. These components are capable of transmitting and receiving data or signals to and from each other via a bus.

The display device 11 is a display device such as a liquid crystal display (LCD) or an organic light-emitting diode (OLED). For example, a plurality of icons are displayed on a screen of the display device 11.

The touch panel 12 is a touch panel of, for example, a so-called resistive-film type or an electrostatic capacitance type. The touch panel 12 is arranged on the screen of the display device 11, detects touch of a finger or the like of a user on the touch panel 12 together with a position of the aforementioned touch, and receives input of instructions to the screen of the display device 11 by the user.

The information processing apparatus 10 includes, as an operation device to which user operation is inputted, the physical key 13 in addition to the touch panel 12 described above.

The network communication device 15 is a communication interface which includes a communication module such as an LAN chip (not illustrated) or the like. The network communication device 15 is connected to, for example, an external terminal device through LAN, the Internet, or the like.

The storage device 18 is a storage device such as a random access memory (RAM) and stores various application programs, various pieces of information, etc.

The control device 19 includes a processor, a random access memory (RAM), a read only memory (ROM), etc. The processor is, for example, a central processing unit (CPU), an application specific integrated circuit (ASIC), or a micro processing unit (MPU). The control device 19 functions as a controller 21 as a result of executing a control program stored in the aforementioned ROM or the storage device 18 by the aforementioned processor.

The control device 19 is connected to the display device 11, the touch panel 12, the physical key 13, the network communication device 15, the storage device 18, etc., and performs operation control of these components and signal or data transmission and reception between the components.

The controller 21 plays a role as a processor which executes various types of processing. The controller 21 also has a function of controlling display operation performed by the display device 11 and communication operation performed by the network communication device 15.

Moreover, the controller 21 identifies user operation inputted by the user based on a detection signal outputted from the touch panel 12. Then the controller 21 receives the identified user operation and performs operation in response to the aforementioned user operation.

The user operation includes touch operation, drag operation, flick operation, etc. For example, when the user has separated his or her finger from the touch panel 12 immediately after touch of the finger on the touch panel 12, the touch panel 12 outputs, to the controller 21, a detection signal indicating a position where the touch has been detected. When the detection signal has been inputted, the controller 21 determines based on this detection signal that the user operation is touch operation and receives this touch operation. The touch operation is, for example, operation for selecting the icon or the like on the screen of the display device 11.

Moreover, when the user has moved his or her finger while making his or her finger in contact with the touch panel 12, the touch panel 12 outputs, to the controller 21, a detection signal indicating each moving position from a start position at which initial touch was detected to a final position at which final touch was detected. When the detection signal has been inputted, the controller 21 determines based on this detection signal that the user operation is drag operation and also determines an operation direction of the drag operation and receives this drag operation. The drag operation is, for example, operation for specifying a character string of a text displayed on the screen of the display device 11.

Moreover, when the user has separated his or her finger from the touch panel 12 after making his or her finger in contact with the touch panel 12 and quickly moving his or her finger at the same time, that is, when operation of flipping the touch panel 12 by the finger has been performed, the touch panel 12 outputs, to the controller 21, a detection signal indicating each moving position from a start position at which initial touch was detected to a final position at which final touch was detected. When the detection signal has been inputted, the controller 21 detects a quick change in the touch position in short time based on this detection signal, determines that the user operation is flick operation and also determines an operation direction of the flick operation, and receives the flick operation. This flick operation is, for example, operation for performing scroll display of contents such as a text or an image displayed on the screen of the display device 11 and instructing search for a character string specified by drag operation to be described later on.

Here, when the user has specified a desired character string of a text through drag operation while the text is displayed on the screen of the display device 11 in the information processing apparatus 10 of this embodiment, the controller 21 detects, through the touch panel 12, a direction of the drag operation and a region of the drag operation (a region from a start position to a final position), and the controller 21 determines whether the direction of the drag operation is a head direction directed towards a head of the text or an end direction directed towards an end of the text and also determines a desired character string in the detected region.

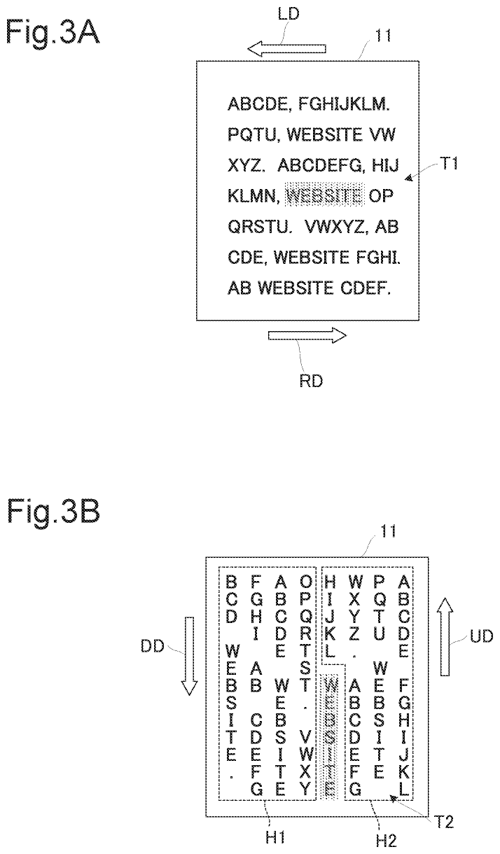

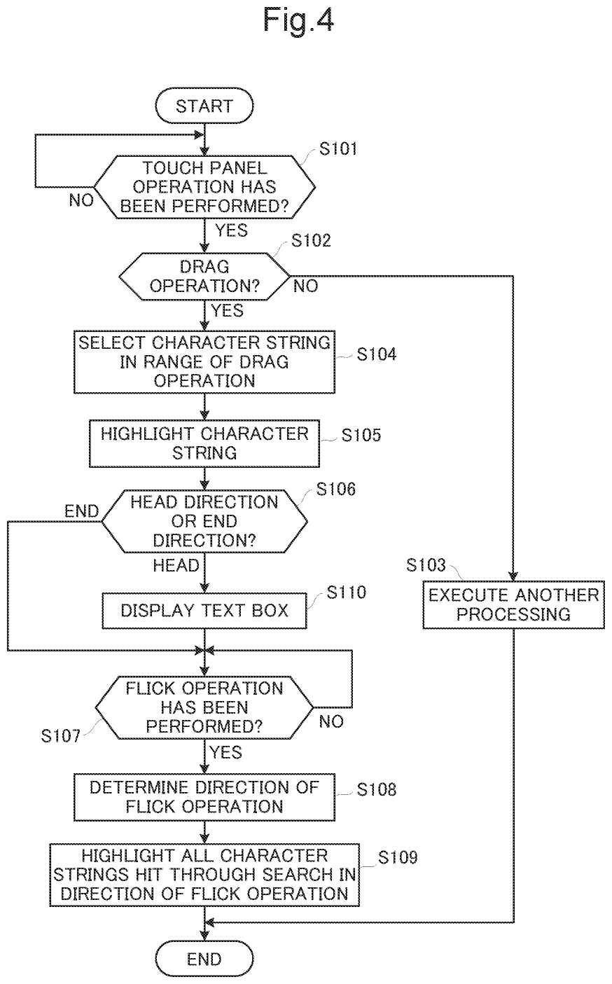

For example, in a case where a text T1 is horizontally written as illustrated in FIG. 3A, a head direction LD of the text T1 is a leftward direction in FIG. 3A and an end direction RD of the text T1 is a rightward direction in FIG. 3A. Moreover, when a text T2 is vertically written as illustrated in FIG. 3B, a head direction UD of the text T2 is an upward direction in FIG. 3B and an end direction DD of the text T2 is a downward direction in FIG. 3B.

In a case where the direction of the aforementioned drag operation is the end direction of the text, the controller 21 stands by for flick operation to be performed on the desired character string following the drag operation. In a case where the user has performed the flick operation on a region of the desired character string of the text, the controller 21 detects, through the touch panel 12, the flick operation performed on the region of the desired character string and a direction of the flick operation and determines whether the detected direction of the flick operation is the head direction or the end direction of the text. Then in a case where the detected direction of the flick operation is the end direction, the controller 21 extracts a range of the text written on a side in the end direction from the desired character string, searches for any character string in agreement with the desired character string in the extracted range, and causes the display device 11 to highlight and display the searched character string on the screen thereof. Moreover, in a case where the detected direction of the flick operation is the head direction, the controller 21 extracts a range of the text written on a side in the head direction from the desired character string, searches for any character string in agreement with the desired character string in the extracted range, and causes the display device 11 to highlight and display the searched character string on the screen thereof.

Moreover, in a case where the direction of the aforementioned drag operation is the head direction, the controller 21 causes a text box, in which the desired character string is entered, to be displayed on the screen of the display device 11. At this point, the user checks the desired character string of the text box and then performs flick operation on the region of the desired character string of the text. The controller 21 detects, through the touch panel 12, the flick operation performed on the region of the desired character string and the direction of the flick operation and determines whether the detected direction of the flick operation is the head direction or the end direction of the text.

Then in a case where the detected direction of the flick operation is the end direction, the controller 21 extracts a range of the text written in the end direction from the desired character string, searches for any character string in agreement with the desired character string in the extracted range, and causes the display device 11 to highlight and display the searched character string on the screen thereof. Moreover, in a case where the direction of the flick operation detected is the head direction, the controller 21 extracts a range of the text written in the head direction from the desired character string, searches for any character string in agreement with the desired character string in the extracted range, and causes the display device 11 to highlight and display the searched character string on the screen thereof.

Therefore, when the user has subsequently performed flick operation in the head direction or the end direction of the text on the region of the desired character string after specifying the desired character string of the text through drag operation performed in the end direction of the text, the range of the text written in the direction of the flick operation from the desired character string is extracted, and any character string in agreement with the desired character string in the extracted range is searched for and highlighted. Thus, the user can search for the desired character string only through the drag operation and the flick operation.

Moreover, in a case where the user has specified the desired character string of the text through drag operation performed in the head direction of the text, the text box in which the desired character string is entered is displayed. This is because the direction of the drag operation towards the head direction of the text is opposite to the flow of the writing of the text and the desired character string can be checked in the text box. When the user has performed flick operation in the head direction or the end direction of the text on the region of the desired character string of the text after checking the desired character string of the text box, the range of the text written in the direction of the flick operation from the desired character string is extracted, and any character string in agreement with the desired character string in the extracted range is searched for and highlighted. In this case, the user can search for the desired character string only through the drag operation and the flick operation.

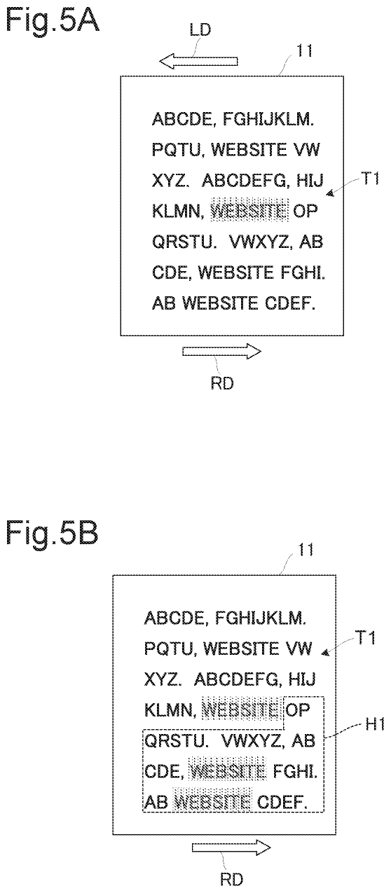

Next, procedures of control for searching for and highlighting a desired character string in accordance with, for example, drag operation and flick operation as described above will be described in detail with reference to, for example, a flowchart illustrated in FIG. 4.

For example, assume that the horizontally written text T1 as illustrated in FIG. 3A is displayed on the screen of the display device 11. The controller 21 stands by for user operation to be performed on the touch panel 12 (“No” in S101), and upon detection based on output from the touch panel that operation is performed on the touch panel 12 (“Yes” in S101), determines whether or not this operation is drag operation in the head direction (leftward direction) LD or the end direction (rightward direction) RD of the text T1 (S102).

At this point, upon determination that the operation performed on the touch panel 12 is not the drag operation in the head direction LD or the end direction RD of the text T1 (“No” in S102), the controller 21 executes another processing which is different from the drag operation and which is in accordance with the determined operation (S103), ending the processing of FIG. 4.

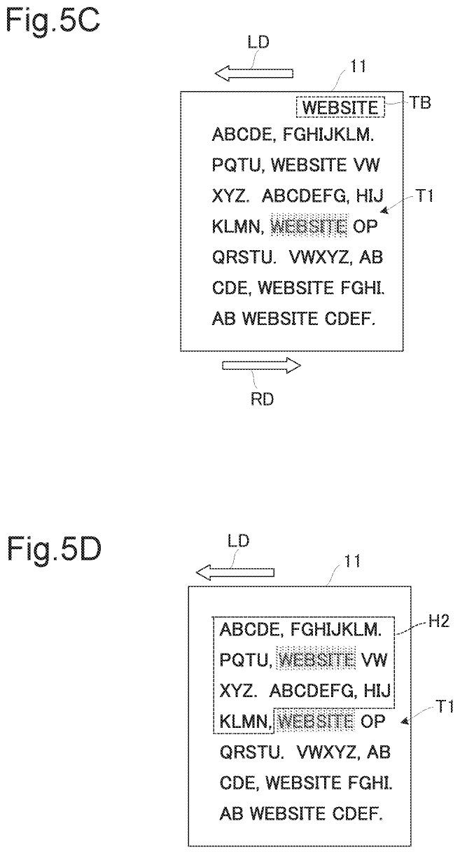

Moreover, upon determination that the operation performed on the touch panel 12 is the drag operation in the head direction LD or the end direction RD of the text T1 (“Yes” in S102), the controller 21 selects the desired character string in the region (the region from the start position to the end position) of the drag operation (S104) and causes the desired character string to be highlighted on the screen of the display device 11 (S105). For example, as illustrated in FIG. 5A, when a region of the desired character string “web site” in the text T1 has been specified through the drag operation, the desired character string “web site” is highlighted.

Then it is determined through the touch panel 12 whether the direction of the drag operation is the head direction LD or the end direction RD (S106).

Upon determination that the operation performed on the touch panel 12 is the drag operation in the head direction LD of the text T1 (“Head” in S106), the controller 21 causes, for example, a text box TB, in which the desired character string “web site” is entered as illustrated in FIG. 5C, to be displayed on the screen of the display device 11 (S110). For example, as illustrated in FIG. 5C, the controller 21 causes the text box TB to be displayed at a predefined section of a margin region (for example, an outer peripheral end region of the screen of the display device 11) other than the region on the screen of the display device 11 where the text T1 is written. Note that in case of the drag operation in the head direction LD, the controller 21 causes display at a section of the margin region (a section of the upper end margin region) on the screen of the display device 11 located on a side in the head direction LD from the region of the desired character string “web site”. Moreover, in case of the drag operation in the end direction RD, the controller 21 causes display at a section of the margin region (a section of the lower end margin region) on the screen of the display device 11 located on a side in the head direction LD from the region of the desired character string “web site”.

On the other hand, upon determination that the operation is drag operation in the end direction RD (“End” in S106), the controller 21 does not perform processing of S110.

Subsequently, the controller 21 stands by for detection of flick operation performed on the region of the desired character string “web site” through the touch panel 12 (“No” in S107). At this point, when the user has performed the flick operation on the region of the desired character string “web site” in the text T1, the controller 21 detects, through the touch panel 12, the flick operation performed on the region of the desired character string “web site” (“Yes” in S107), and determines whether a direction of this flick operation is the head direction LD or the end direction RD of the text T1 (S108). Then the controller 21 extracts a range of the text written in the determined direction of the flick operation from the desired character string “web site”, searches for any character string in agreement with the desired character string in the extracted range, and causes the character string hit through this search to be highlighted on the screen of the display device 11 (S109). Then the processing ends.

For example, in a case where the direction of the flick operation is the end direction RD, as illustrated in an example of FIG. 5B, a range H1 of the text written in the end direction RD from the desired character string “web site” is extracted and all the desired character strings “web site” as those hit through the search in the extracted range H1 are searched for and highlighted.

On the other hand, when the direction of the flick operation is the head direction LD, as illustrated in an example of FIG. 5D, a range H2 of the text written in the head direction LD from the desired character string “web site” is extracted and all the desired character strings “web site” in the extracted range H2 are searched for and highlighted

In this embodiment as described above, when flick operation has been subsequently performed on the region of the desired character string after the desired character string of the text was specified through the drag operation in the end direction of the text, the desired character string in the range of the text written in the direction of the flick operation from the desired character string is searched for and highlighted, thus making it possible for the user to search for the desired character string through simple operation.

In a conventional information processing apparatus described in Background above, in a case where search for a desired character string has been instructed after the desired character string was inputted through keyboard operation, or in a case where execution of search for a word has been instructed after the word was specified through keyboard or touch panel operation as in a conventional electronic device described in Background above, the keyboard or touch panel operation is still complicated, requiring further improvement.

On the contrary, it is possible in this embodiment to enable specification of and search for a character string of a text through simple operation.

Moreover, when a desired character string of a text has been specified through drag operation in a head direction of the text, that is, a direction opposite to a flow in which the text is written, a text box in which the desired character string is entered is displayed, thus making it possible for the user to check the desired character string in the text box and then instruct search for the desired character string through flick operation.

Note that the horizontally written text T1 is provided as an example as illustrated in FIG. 3A, but even in a case where the vertically written text T2 as illustrated in FIG. 3B is displayed on the screen of the display device 11, when the flick operation has been subsequently performed on the region of the desired character string “web site” after the desired character string “web site” was specified through the drag operation performed in the end direction DD of the text T2, the controller 21 extracts the range H1 of the text written in the direction of the flick operation from the desired character string “web site”, searches for any character string in agreement with the desired character string “web site” in the range H1, and causes the searched character string to be highlighted. Moreover, when the desired character string “web site” has been specified through the drag operation performed in the head direction UD of the text T2, when the flick operation has been subsequently performed on the region of the desired character string “web site” after the text box TB in which the desired character string is entered was caused to be displayed on the screen of the display device 11, the controller 21 extracts the range H1 of the text written in the direction of the flick operation from the desired character string “web site”, searches for any character string in agreement with the desired character string “web site” in the range H1, and causes the aforementioned character string to be highlighted.

Moreover, in the embodiment described above, in a case where the direction of the drag operation is the head direction of the text, the controller 21 causes the text box, in which the desired character string is entered, to be displayed, but may cause the same text box to be displayed even in a case where the direction of the drag operation is the end direction of the text.

Moreover, in the embodiment described above, when the flick operation has been subsequently performed after the desired character string was specified through the drag operation, the controller 21 extracts the range of the text written in the direction of the flick operation from the desired character string, searches for the desired character string in the extracted range, and causes the aforementioned desired character string to be highlighted. However, when the flick operation has been subsequently performed on the region of the desired character string after the desired character string was specified through the drag operation, the controller 21 may search for all the character strings in agreement with the desired character string in the entire text and cause the aforementioned desired character strings to be highlighted regardless of the direction of the flick operation.

Moreover, in the embodiment described above, the controller 21 extracts the range of the text written in the direction of the flick operation from the desired character string, but the controller 21 may extract a range of the text written in the direction of the drag operation (the end direction or the head direction) from the desired character string. In this case, the flick operation is performed only for instructing start of the search for the desired character string.

Moreover, instead of highlighting the desired character string, a character style of the desired character string may be changed or the desired character string may be underlined.

Moreover, the configuration of the embodiment described above with reference to FIGS. 1 to 5D is just one example of this disclosure and it is not intended to limit this disclosure to this configuration.

While the present disclosure has been described in detail with reference to the embodiments thereof, it would be apparent to those skilled in the art the various changes and modifications may be made therein within the scope defined by the appended claims.

What is claimed is:

1. An information processing apparatus comprising:
a display device;
a touch panel provided on a screen of the display device; and
a control device including a processor and, as a result of executing a control program by the processor, functioning as a controller causing the display device to display a text on the screen thereof, determining, through the touch panel, drag operation performed on a desired character string of the text displayed on the screen of the display device, and upon determination of flick operation performed on the desired character string following the drag operation, searching for a character string in agreement with the desired character string in the text subjected to the drag operation, and causing the display device to display the character string searched for, by changing a display mode thereof.

2. The information processing apparatus according to claim 1, wherein
the controller determines, through the touch panel, whether a direction of the drag operation or the flick operation is a head direction directed to a head of the text or an end direction directed to an end of the text, extracts a range of the text written in the determined direction from the desired character string, and searches for the character string in agreement with the desired character string in the extracted range.

3. The information processing apparatus according to claim 1, wherein
the controller determines, through the touch panel, whether a direction of the drag operation is a head direction directed to a head of the text or an end direction directed to an end of the text, in a case where the determined direction is the end direction, determines, through the touch panel, whether a direction of the flick operation is the head direction or the end direction of the text, extracts a range of the text written in the determined direction of the flick operation from the desired character string, and searches for the character string in agreement with the desired character string in the extracted range.

4. The information processing apparatus according to claim 3, wherein
in a case where the determined direction of the drag operation is the head direction of the text, the controller causes the display device to display a text box in which the desired character string is entered, determines whether the direction of the flick operation is the head direction or the end direction of the text, extracts the range of the text written in the determined direction of the flick operation from the desired character string, and searches for the character string in agreement with the desired character string in the extracted range.

5. The information processing apparatus according to claim 4, wherein
the controller causes the text box to be displayed at a predefined section of a margin region other than a region on the screen of the display device where the text is written.

6. The information processing apparatus according to claim 1, wherein
when, following the drag operation, the flick operation performed on the desired character string is determined, the controller extracts a range of the text written in a head direction from the desired character string and a range of the text written in an end direction from the desired character string regardless of the direction of the flick operation, and searches for the character string in agreement with the desired character string in the extracted ranges.

7. The information processing apparatus according to claim 1, wherein
the text is formed of a plurality of vertical rows, and
a head direction of the text is an upward direction extending along each of the vertical rows and an end direction of the text is a downward direction extending along each of the vertical rows.

8. The information processing apparatus according to claim 1, wherein
the text is formed of a plurality of horizontal rows, and
a head direction of the text is a leftward direction extending along each of the horizontal rows and an end direction of the text is a rightward direction extending along each of the horizontal rows.
